(19) United States
(12) Patent Application Publication
(10) Pub. No.: US 2013/0039452 A1
(43) Pub. Date: Feb. 14, 2013

(54) Fusion of photonic solenoids

(71) Applicant: Robert Paul Johnson, Glendale, AZ (US)

(72) Inventor: Robert Paul Johnson, Glendale, AZ (US)

(21) Appl. No.: 13/507,569

(22) Filed: Jul. 11, 2012

Related U.S. Application Data
(60) Provisional application No. 61/572,737, filed on Jul. 21, 2011.

(51) Int. Cl. G21B 1/05

(52) U.S. Cl. 376/121

(57) ABSTRACT

This invention teaches methods of improving the viability, efficiency and sustainability of particle fusion based on the underlying electromagnetic structure of fundamental particles and the resulting photonic solenoid interactions.

### CROSS-REFERENCE TO RELATED APPLICATIONS

This Application claims priority and benefits of Provisional Patent Application 61/572,737.

### FEDERALLY SPONSORED RESEARCH

None

### SEQUENCE LISTING

None

### BACKGROUND OF THE INVENTION

1. Field of Invention

This invention relates to nuclear fusion.

2. Description of Prior Art

Particle fusion is a source of energy. Fusion results from a strong, short-range bonding mechanism that is not fully understood which overcomes the electrostatic repulsion between charges of like particles. The simplest form of nuclear fusion is between two positive hydrogen ions, or positive ionic isotopes of hydrogen. Numerous devices and methods for controllably producing fusion are found in the literature. Magnetic confinement of plasma streams at extreme temperatures is presently the most promising research.

### SUMMARY OF THE INVENTION

Current mainstream thinking is that hadrons are a product of constituent sub-particles. This invention discloses a focused method of producing particle fusion in a sustainable manner. A novel teaching of the electromagnetic structure of particles makes this possible.

Pair production suggests half waves yield oppositely charged antiparticles, and beta decay produces stable, oppositely charged electrons and protons. Formation of balanced, elementary charges by both processes suggests a common charge producing mechanism. This invention asserts that all particles, including hadrons, are a three-dimensional form of electromagnetism. Maxwell's law of induction is more instructive written as c [symbol] B•ds=(1/c)dΦ_{E}/dt. This form of his equation expresses the momentum of a magnetic field propagating at c as a 1/c ratio to the inducing electric flux. According to Faraday's law of induction, an electric field varies with changing magnetic flux where [symbol] E•ds=−dΦ_{B}/dt. Faraday's law makes no statement about electric field momentum or magnitude. For a propagating electric field, Faraday's law becomes c [symbol] E•ds=−cdΦ_{B}/dt. In both field-momentum equations, the fields on the left sides of the equations propagate at the speed of light, and each propagating field has an E/B=c magnitude ratio to their respective inducing fluxes. Propagation of an electromagnetic wave depends on the ratio of electric and magnetic fluxes according to J. J. Thomson's velocity equation, E/B=v. Multiplying E/B by c/c, as happens on the left sides of the field-momentum equations, yields (Ec)/(Bc)=c. If the magnetic field loses its translational velocity c as does mass, then (Ec)/B is proportional to e/m, when e=mc². While e/m is the ratio of energy to mass, (Ec)/B describes the step by which electromagnetic energy produces mass. Mass and the magnetic fields are thusly related. Accordingly, (Ec)/(Bc)=c describes a wave and (Ec)/B=c² describes a particle. Half the energy of a photon is transported by each field, but only the electric field of a particle retains translational velocity c. Hence, Ec=½mc², Bc=½mc² and B=½mc.

Gauss's laws describe the structure of electromagnetic mass. Gauss's law for magnetism [symbol] B•dA=0 requires the magnetic field act in the plane of the particle surface since magnetic monopoles are not found. If the magnetic field acts in the plane of the particle surface, then the electric field must be normal to the surface. This agrees with Gauss's law for electricity where [symbol] E•dA=q/εₒ. Electrons exhibit point charges. The electric field of a point charge, q, is given by E=(4πr²)⁻²q/εₒ. For the point charge, the area of the integral describes a spherical Gaussian surface. Non-translating magnetic field B forms this surface. Transverse propagating electric field Ec conforms to the magnetic surface, producing point-charge q coinciding with the geometric center of mass. Gauss's laws thusly describe particles with spherical, magnetic rest-surfaces 4πrₓ² that by the symmetry of (Ec)/B=c² and e/m=c², equate to mass.

Given that Eₓc=G(½mₓc²/2πrₓ), then 4πrₓ²=G(½mₓc/π), with mₓ being the mass of particle x and rₓ is the spherical radius of magnetic field Bₓ. Eₓc=G(½mₓc²/2πrₓ) is an equatorial function. Two-dimensional electric field Eₓ encircles its normal axis that extends through the focus of spherical surface 4πrₓ², which is magnetic field Bₓ with rest energy ½mₓc distributed angularly between axial poles b⁺ and b⁻. Circular momentum Eₓc induces axially-bipolar magnetic field Bₓ and charge e^{±} at the electric-field focus. Together, the two equations describe a perpetual photonic solenoid. Photonic solenoids have the charge producing mechanism common to both pair production and beta decay when Eₓc is a half wave propagating along the equatorial path around the particle axis, and curvature of the path is opposite the half-wave amplitude, which lies in the equatorial plane. Magnetic field Bₓ forming the three-dimensional particle surface aligns accordingly. Relative to the same north-south magnetic alignment, oppositely charged particles have antiparallel Eₓc velocity vectors. Protons have a mass of 1.6726×10⁻²⁷ kilograms. Their cross-section of 2rₚ is 1.302×10⁻¹⁵ meters. Repelling charges e⁺ at the foci of Eₚc are 2rₚ apart when attracting, axial poles b⁺ and b⁻ on the surfaces of two adjacent protons touch. By Coulomb's law, when the distance between attracting magnetic poles is zero, the difference in force potentials becomes b≧±(μₒ/εₒ)½e, meaning induced charges e⁺ radiate and poles b^{±} do not. Bipolar photonic solenoids thusly provide a strong, short-range mechanism for fusion.

Fusion of hydrogen follows 4₁¹H→2₁²H+2₁⁰β→₂⁴He+2₁⁰β. Intermediate formation of deuterium suggests that, relative to the turning Eₓc vector, nπ/2-directed fields occur, with n being an integer. Neutral particles have electric field amplitudes aligned with their Eₓc vector. Electric fields having an instantaneous, longitudinal orientation do not point toward or away from the particle focus and do not form monopolar, field foci. Accordingly, field momentum, Eₓc, and the presence or absence of an electric-field focus, produce either a charge of e^{±} or e°.

This novel photonic-solenoid structure and its resulting bonding mechanism yield a means to improve fusion reactions. Fusing two colliding particles depends upon the orientation of the axial magnetic poles of the particles as the collision occurs. Aligning the axial magnetic poles of particles with their coincident collision path and orientating the axial North and South poles of both said particles in the same direction so that attracting magnetic poles on each particle's surface touch as the particles collide, maximizes the likelihood of nuclear fusion.

Increasing the rate of fusion as a percentage of a given number of collisions decreases energy expended ionizing hydrogen or its isotopes. Maximizing the attractive magnetic force acting between colliding particles minimizes energy expended creating confinement and/or particle momentum necessary to overcome the repulsive force of like charges.

Aligning the axial magnetic poles of colliding particles along their coincident collision paths can be accomplished by making the coincident collision paths parallel and antiparallel to a magnetic flux extending along the axial center of a linear or toroidal solenoid, or between magnets, and causing the collision of the particles to occur inside the aligning magnetic flux.

As a rate of fusion as a function of the time rate of particle collisions is established, the rate of fusion can be modulated by controlling the rate of ion production, and, when electric current is used to produce the magnetic field that aligns said colliding particles, the rate of fusion can be modulated by controlling the electric current producing said magnetic field. As the magnetic field controlling particle alignment diminishes, the rate of fusing collisions declines. Controlling the time rate of fusion allows continuous operation within the mechanical and thermodynamic limits of a fusion cell, thereby yielding a sustainable production of usable energy.

### BRIEF DESCRIPTION OF DRAWINGS

FIG. 1 illustrates alignment by a third magnetic field of the axial poles of two colliding particles.

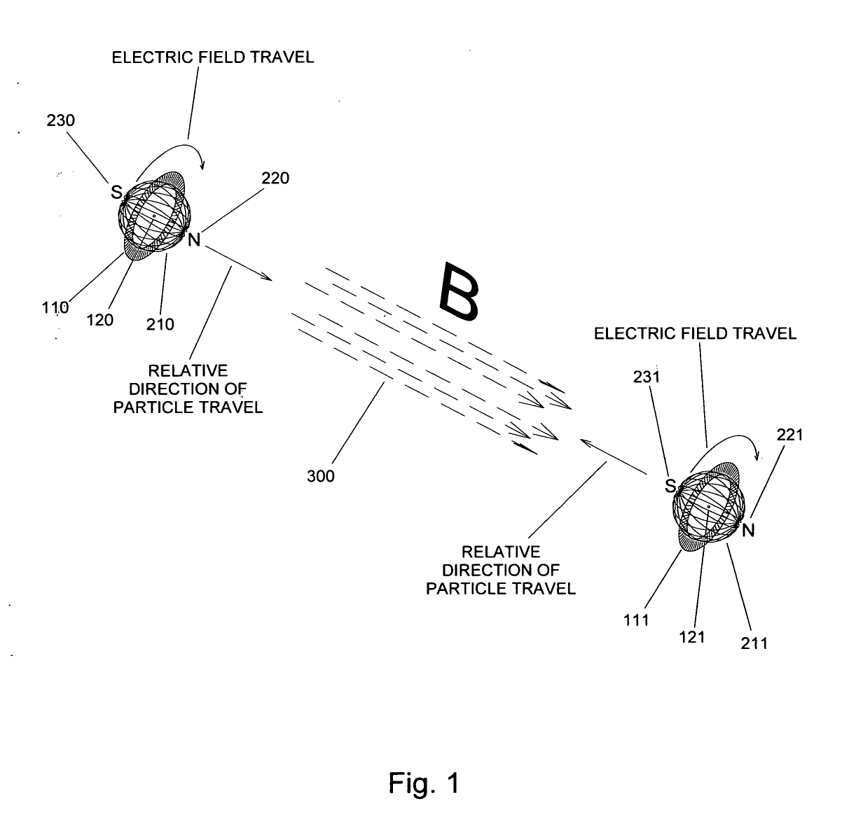

### DESCRIPTION OF PRESENTED EMBODIMENT

Relative directions of travel of two particles, one particle comprised of electric field 110 and magnetic field 210 and the other particle comprised of electric field 111 and magnetic field 211, are antiparallel and said particles are on a collision path. Electric fields 110 and 111 travel along circular paths around the geometric foci formed by magnetic fields 210 and 211. Foci 120 and 121 of said electric fields 110 and 111, respectively, coincide with the geometric foci formed by magnetic fields 210 and 211, respectively. Magnetic field foci, 220 and 230 of magnetic field 210 and 221 and 231 of magnetic field 211, are designated attracting magnetic poles N and S. The relative coincident paths of said particles are parallel and/or antiparallel to magnetic flux 300. The direction of magnetic flux 300 causes magnetic poles 220 and 230 of magnetic field 210 and magnetic poles 221 and 231 of magnetic field 211 to linearly align in a manner such that magnetic pole 220 meets attracting magnetic pole 231 when said particles collide.

I claim the following:

1. A method of fusing particles comprising joining a first magnetic field and a second magnetic field, each said field first being the separate surface of each of two particles that fuse whereby the attracting force between adjacent magnetic poles of said two fields, fuses said particles.

2. The method of claim 1 wherein said attracting force results from a magnetic pole potential that is equal to or greater than the electric field potential of the mutually-repelling charges of said two particles that fuse, by the square root of the ratio of the magnetic permeability of free space μₒ to the electric permittivity of free space εₒ, stated symbolically, b≧±(μₒ/ε₀)^{1/2}e, in which b is an axial magnetic pole of said particle surface and e is the particle charge.

3. The method of claim 1 wherein said particles that fuse in the manner of claim 1 are protons, deuterons, tritons and/or electrons.

4. The method of claim 1 whereby said fusion of said particles produces useful energy.

5. A method of enhancing the likelihood of fusing particles comprising aligning the axial magnetic poles of colliding particles with the coincident paths of said particles so that as said particles meet, mutually-attracting magnetic poles, one said mutually-attracting magnetic pole being on each said colliding particle, are disposed on the surfaces of said particles nearest the points where said particles first meet, thereby quickly developing an aligned magnetic bond.

6. The method of claim 5 whereby fusion of said particles produces useful energy.

7. The method of claim 5 whereby the efficiency of nuclear fusion is improved by increasing the rate that particles fuse as a percentage of the number of times that particles collide, and in the converse, decreasing the rate that particles fail to fuse as a percentage of the number of times that particles collide.

8. The method of claim 5 wherein when said particles collide the axial magnetic poles of said colliding particles are aligned by a method comprising aligning the coincident collision paths of said particles parallel and/or antiparallel to a third magnetic field of sufficient influence to align the axial magnetic poles of said particles as in claim 5 and wherein said particles are under the influence of said third magnetic field at the place where said particles collide.

9. The method of claim 8 wherein said third magnetic field having sufficient influence to align said axial magnetic poles of said colliding particles as in claim 8 is produced by electric current that passes through the windings of a solenoid, including a toroidal solenoid.

10. The method of claim 8 wherein said third magnetic field having sufficient influence to align said axial magnetic poles of said colliding particles as in claim 8 is produced by electric current that magnetizes an electromagnet.

11. The method of claim 8 wherein said third magnetic field having sufficient influence to align said axial magnetic poles of said colliding particles as in claim 8 is produced by permanent magnetism.

12. The method of claim 8 whereby sustainability of fusion reactors is improved by controlling the alignment of said axial poles of said colliding particles by varying the influence of said third magnetic field when safe operating parameters of said reactors reach a predetermined limit.

13. The method of claim 8 wherein magnetic dipoles of deuterons and tritons are longer than that of a proton, making deuterons and tritons align in a weaker, said third magnetic field.
